(19) United States
(12) Patent Application Publication
(10) Pub. No.: US 2021/0042601 A1
(43) Pub. Date: Feb. 11, 2021

(54) METHOD AND DEVICE FOR ENCRYPTING MODEL OF NEURAL NETWORK, AND STORAGE MEDIUM

(71) Applicant: BEIJING XIAOMI MOBILE SOFTWARE CO., LTD., Beijing (CN)

(72) Inventors: Qi LIU, Beijing (CN); Jianwu YE, Beijing (CN); Liangliang HE, Beijing (CN)

(73) Assignee: BEIJING XIAOMI MOBILE SOFTWARE CO., LTD., Beijing (CN)

(21) Appl. No.: 16/695,164

(22) Filed: Nov. 25, 2019

(30) Foreign Application Priority Data
Aug. 9, 2019 (CN) 201910735898.X

(51) Int. Cl. G06N 3/04; G06F 8/76; G06F 8/61; G06F 8/41; H04L 9/06

(52) U.S. Cl. CPC G06N 3/04; G06F 8/76; H04L 9/0643; G06F 8/41; G06F 8/61

(57) ABSTRACT

An encrypted model file is acquired by encrypting at least a part of model information in an original model file. The original model file describes a target neural network model. A model program code is generated according to the encrypted model file. The model program code describes the target neural network model. An installation package for installing an application (APP) is sent to a User Equipment (UE) based on a request sent by the UE. The installation package includes the model program code.

### CROSS-REFERENCE TO RELATED APPLICATION

This application claims priority to Chinese patent application No. 201910735898.X filed on Aug. 9, 2019, the disclosure of which is hereby incorporated by reference in its entirety.

### BACKGROUND

A neural network model is a mathematical model simulating a real neural network of a human being, and may apply widely to fields such as system recognition, mode identification, artificial intelligence, etc. As neural network technology continues to mature, a neural network model has been applied to application (APP) products of numerous kinds of User Equipment (UE). Application of a neural network model often involves an issue of security. Model information may tend to be given away when a neural network model is deployed at a UE side. Therefore, a major topic in application of a neural network model is to find a solution for encrypting the neural network model.

### SUMMARY

The subject disclosure relates to information processing, and more specifically to a method and device for encrypting a neural network model, and a storage medium.

According to an aspect of embodiments herein, a method for encrypting a neural network model includes:

acquiring an encrypted model file by encrypting at least a part of model information in an original model file describing a target neural network model;

generating, according to the encrypted model file, a model program code describing the target neural network model; and

sending, to a User Equipment (UE) based on a request sent by the UE, an installation package for installing an application (APP), the installation package including the model program code.

According to an aspect of embodiments herein, a device for encrypting a neural network model includes at least a processor and memory.

The memory stores an instruction executable by the processor.

When executed by the processor, the instruction implements at least a part of any aforementioned method.

According to an aspect of embodiments herein, a non-transitory computer-readable storage medium has stored thereon computer-executable instructions that, when executed by a processor, cause the processor to implement at least a part of any aforementioned method.

The above general description and elaboration below are but exemplary and explanatory, and do not limit the subject disclosure.

### BRIEF DESCRIPTION OF THE DRAWINGS

The accompanying drawings referred to in the specification are a part of this disclosure, and provide illustrative embodiments consistent with the disclosure and, together with the detailed description, serve to illustrate some embodiments of the disclosure.

FIG. 1 is a flowchart of a method for encrypting a neural network model according to some embodiments of the present disclosure.

FIG. 2 is a diagram of a principle of encrypting a neural network model according to some embodiments of the present disclosure.

FIG. 3 is a diagram of a structure of a device for encrypting a neural network model according to some embodiments of the present disclosure.

FIG. 4 is a block diagram of a physical structure of a device for encrypting a neural network model according to some embodiments of the present disclosure.

FIG. 5 is a block diagram of a physical structure of a UE according to some embodiments of the present disclosure.

### DETAILED DESCRIPTION

Exemplary embodiments (examples of which are illustrated in the accompanying drawings) are elaborated below. The following description refers to the accompanying drawings, in which identical or similar elements in two drawings are denoted by identical reference numerals unless indicated otherwise. The exemplary implementation modes may take on multiple forms, and should not be taken as being limited to examples illustrated herein. Instead, by providing such implementation modes, embodiments herein may become more comprehensive and complete, and comprehensive concept of the exemplary implementation modes may be delivered to those skilled in the art. Implementations set forth in the following exemplary embodiments do not represent all implementations in accordance with the subject disclosure. Rather, they are merely examples of the apparatus and method in accordance with certain aspects herein as recited in the accompanying claims.

A term used in an embodiment herein is merely for describing the embodiment instead of limiting the subject disclosure. A singular form “a” and “the” used in an embodiment herein and the appended claims may also be intended to include a plural form, unless clearly indicated otherwise by context. Further note that a term “and/or” used herein may refer to and contain any combination or all possible combinations of one or more associated listed items.

Note that although a term such as first, second, third may be adopted in an embodiment herein to describe various kinds of information, such information should not be limited to such a term. Such a term is merely for distinguishing information of the same type. For example, without departing from the scope of the embodiments herein, the first information may also be referred to as the second information. Similarly, the second information may also be referred to as the first information. Depending on the context, a “if” as used herein may be interpreted as “when” or “while” or “in response to determining that”.

In addition, described characteristics, structures or features may be combined in one or more implementation modes in any proper manner. In the following descriptions, many details are provided to allow a full understanding of embodiments herein. However, those skilled in the art will know that the technical solutions of embodiments herein may be carried out without one or more of the details; alternatively, another method, component, device, option, etc. may be adopted. Under other conditions, no detail of a known structure, method, device, implementation, material or operation may be shown or described to avoid obscuring aspects of embodiments herein.

A block diagram shown in the accompanying drawings may be a functional entity which may not necessarily correspond to a physically or logically independent entity. Such a functional entity may be implemented in form of software, in one or more hardware modules or integrated circuits, or in different networks and/or processor devices and/or microcontroller devices.

In general, a neural network model may be deployed in two modes. One is to deploy a neural network model at a server to provide an online service through a network. The other is to deploy a neural network model at a UE side including a smart UE such as a mobile phone, to execute the model off line using an accelerator at the UE side. When a model is deployed at a UE side, all information on the model may be stored in a model file. Model information may be acquired straightforwardly through the model file, leading to poor security.

A neural network model may be encrypted by at least one of symmetric encryption or asymmetric encryption. A neural network model may be encrypted in two symmetric encryption modes, i.e., stream cipher encryption and block cipher encryption. With stream cipher encryption, one letter or digit may be encrypted at a time. With block cipher encryption, a data block including multiple bits may be encrypted into one unit. Multiple data blocks may have to be filled with plaintext. Block cipher encryption may include a Data Encryption Standard (DES) algorithm, a Triple DES (TDES) algorithm, an Advanced Encryption Standard (AES) algorithm, a Blowfish algorithm, an International Data Encryption Algorithm (IDEA), an RC5 algorithm, an RC6 algorithm, etc.

A system of asymmetric encryption may use a key pair. A key pair may include two keys, i.e., a public key and a private key. A public key may be spread widely. A private key may be known only to an owner. Cipher text may be encrypted using a public key and decrypted by a receiver using a private key. With asymmetric encryption, data are highly encrypted and are unlikely to be cracked straightforwardly, leading to high security, as long as the private key is secured. Asymmetric encryption may include an RSA encryption algorithm, for example.

A key of symmetric encryption, as well as a private key of asymmetric encryption, as mentioned above, will be stored in a code at a UE side, thus posing a potential security issue. Moreover, asymmetric encryption may require complicated decryption, leading to low efficiency.

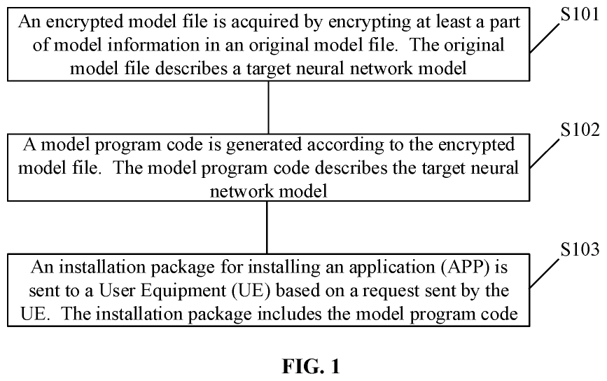

FIG. 1 is a flowchart of a method for encrypting a neural network model according to some embodiments of the present disclosure. As shown in FIG. 1, the method includes at least one option as follows.

In S101, an encrypted model file is acquired by encrypting at least a part of model information in an original model file. The original model file describes a target neural network model.

In S102, a model program code is generated according to the encrypted model file. The model program code describes the target neural network model.

In S103, an installation package for installing an application (APP) is sent to a User Equipment (UE) based on a request sent by the UE. The installation package includes the model program code.

Encryption in S101 and S102 may be executed off line by a server. After encryption, an installation package for installing an APP, which includes a model program code, may be generated, so as to be downloaded and used by a UE. When a request (including, but not limited to, a download request, an update request, or the like, for example) sent by a UE is received, the server may send the installation package for installing the APP to the UE. The UE may install and run the APP to implement a function of the target neural network model.

The encrypted model file may be acquired by converting the model information into encrypted model information by encrypting a part or all of the model information in the original neural network model using an encryption algorithm. The model information may include node information on each node in the target neural network model. The model information may include a global parameter of the entire model file. The node information may include a node identifier of the each node, a node parameter of the each node, etc. The node parameter may be information such as a weight of the node, an operational parameter of the each node, an attribute parameter of the node, input to the node, output of the node, etc. Information on the input to the node and the output of the node may reflect the structure of the neural network model.

By encrypting at least a part of model information of a target neural network, relevant information in the model may be concealed, avoiding full exposure of all information on the entire model, thereby improving security performance of the model.

In general, an original model file of a neural network may be a file of a specific structure, including a text document, a graphic file, a file in another form, etc. For example, an original model file may be a file in a binary format. An original model file may be a file in a format defined as needed. For example, for a format defined based on Protocol Buffers (protobuf, a data describing language), the original model file may be a protobuf serialized file. An original model file may be a text file in a format such as JavaScript Object Notation (j son). When such an original model file is used at a UE side, model information in a model file of a neural network may be learned straightforwardly through the original model file, leading to poor security. Even an encrypted model with improved security performed may still be cracked. Therefore, after model information is encrypted, an encrypted target neural network may be converted into a code, further improving overall security performance of the neural network model.

That is, by describing a target neural network model using a code, a common file may be converted into an underlying code, increasing difficulty in cracking the file. Moreover, a part of model information of the target neural network may have been encrypted and then converted into a code, making it more difficult to be cracked. The code may be implemented using various program languages. The code may be implemented using various object-oriented program languages. Exemplarily, an object-oriented program language may include, but is not limited to, C++, JAVA, C#, etc.

At a server side, a part of model information in an original model file of a neural network may be encrypted. The encrypted model file may be converted into a model program code describing the neural network. The model program code may be sent to a UE side. Thus, when sending an installation package for installing an APP to a UE, a server may not have to send an original model file (such as a file in a binary format) to the UE, improving efficiency in transmission. In addition, by converting an encrypted model file into a model program code, difficulty in cracking the cipher text is increased greatly, thereby ensuring security of the entire model. On the other hand, when a neural network is deployed off line at a UE side, an original model file may not have to be stored, saving storage space, better meeting a demand for off-line deployment at the UE side. In addition, model information of a neural network may be acquired merely by running a model program code without a need to call an original model file external to the APP, improving efficiency in acquiring information on the neural network, thereby improving overall efficiency in running the APP. Moreover, a server may not have to send a key to a UE side, improving security of transmission, ensuring security of information internal to a model.

An encrypted model file may be acquired by encrypting at least a part of model information in a model file of a target neural network off line at a server side. A program file containing the code may be generated according to the encrypted model file. An installation package may be generated according to the program file.

The server may send the installation package to a UE upon a request by the UE.

The UE may install the program file according to the installation package.

The UE may run the program file to acquire each parameter in the neural network model.

The model information may include node information on each node in the target neural network model. The model information may include a global parameter of the target neural network model.

The node information may include a node identifier of the each node, a node parameter of the each node, etc.

The node parameter may include at least one of a weight parameter of the each node, an input parameter of the each node, an output parameter of the each node, an operational parameter of the each node, etc.

A node identifier may be information for identifying a node, such as a name of the node, a numbering of the node, etc. During encryption of model information, a node identifier may be encrypted, thereby concealing information on an identity of a node, resulting in model information containing an encrypted node identifier. The encrypted node identifier may be the node identifier encrypted using an encryption algorithm.

A node identifier may serve to indicate a node participating in an operation in a neural network. An operation may be convolution, weighting, etc., of an operating node in a neural network.

Encryption may be performed only on a node identifier may be encrypted.

Encryption may be performed on at least one of a node identifier or a node parameter. A node parameter may serve to represent a relation between a node and a function of the node. A node parameter may be a weight parameter. A node parameter may be an operational parameter. An operational parameter may describe an operating function or attribute of a node. A node parameter may be an input/output (I/O) parameter of a node. An I/O parameter of a node may reflect a relation of inter-node connection, as well as the structure of a target neural network. Therefore, encryption of a node parameter may ensure security of information internal to a target neural network model.

Encryption may be performed on a global parameter of a target neural network model. A global parameter may describe an input to a target neural network, or an output, a function, an attribute, a structure, etc., of the target neural network. Encryption of a global parameter may improve security of information internal to a target neural network model.

Model information of a model file of a neural network may be encrypted by encrypting a part or all of node information, or by encrypting information relevant to a part or all of global parameters. An encrypted model file may be converted into a model program code describing the neural network. The model program code is to be sent to a UE side. In a practical application, different information may be encrypted as needed. Since there is no fixed requirement as to what content is to be encrypted, efficiency in encryption is improved, further increasing difficulty in cracking the cipher text.

In S102, the model program code describing the target neural network model may be generated according to the encrypted model file as follows.

In S11, a generalized model class associated with the target neural network model may be constructed. At least one generalized data class associated with the model information contained in the target neural network model may be constructed.

In S12, a model object associated with the target neural network model may be created according to the encrypted model file by calling a model constructing function associated with the generalized model class.

In S13, a data object associated with the model information may be created according to the encrypted model file by calling at least one data constructing function associated with the at least one generalized data class.

In S14, the model program code may be generated according to the model object and the data object. The model program code may describe the target neural network model.

The generalized model class may describe various models of target neural networks. In some embodiments, only one universal generalized model class may be defined to describe all models of target neural networks. In another example, multiple distinct generalized model class may be defined according to classification of a target neural network model. For example, one generalized model class may be abstracted from multiple models of target neural networks of a class with a specific attribute, structure, or function, etc. In some embodiments, a generalized model class may have at least one submodel class dedicated to one or more models of target neural networks. Therefore, in S12, for example, a generalized model class and/or a submodel class thereof may be selected corresponding to a type of a target neural network model described by an encrypted model file.

An aforementioned generalized data class may include a generalized class of node data, a generalized class of global data, etc. A generalized class of node data may include generalized classes of node data corresponding respectively to various types of node information. A generalized class of node data may include multiple distinct generalized classes of node data. Each generalized class of node data may correspond respectively to one entry in the node information. In some embodiments, each generalized class of node data may correspond to a combination of multiple entries in the node information.

In other words, one or more node parameters in the node information may be encapsulated in one generalized class of node data. For example, a generalized class of node data may include, but is not limited to, a class of node I/O, a class of node operational parameters, a class of node attributes, a class of node weight parameters, etc.

A generalized class of global data may include only one class of global parameters. A generalized class of global data may include multiple distinct classes of global parameters. One or more global parameters of a model may be encapsulated in one generalized class of global data. For example, a generalized class of global data may include, but is not limited to, a class of model I/O, a class of model functions, a class of model attributes, a class of model structures, etc.

A model object corresponding to a target neural network model may be created based on an aforementioned generalized model class. Multiple data objects corresponding respectively to a global parameter and various entries of node information in a target neural network model may be created based on a generalized data class. Thereby, a model program code describing the target neural network model may be acquired. An original model file may generally describe a graph structure of the neural network model. During generation of a model program code, each encrypted model file may be expressed as a model object of a generalized model class. Multiple data objects of multiple generalized data class may be created by reading information on the graph structure in the encrypted model file. For example, in some embodiments, in S13, information on a parameter and a structure of a model recorded in the encrypted model file may be acquired. Then, at least one generalized data class corresponding to the information on the parameter and the structure of the model may be selected. The data object associated with the information on the parameter and the structure of the model may be created by calling the at least one data constructing function associated with the at least one generalized data class.

In other words, the graph structure of the original model file may be converted, using a code, to be organized by generalized classes of different layers. Thus, information in the original model file may be converted into various objects through various constructing functions. Accordingly, when a neural network is deployed off line at a UE side, the original model file may not have to be stored, so that no additional storage space is occupied, better meeting a demand for off-line deployment at the UE side. In addition, a model program code may be run and model information of a neural network may be acquired through various objects constructed based on the generalized classes of different layers, without a need to call an original model file external to the APP, improving efficiency in acquiring information on the neural network, thereby improving overall efficiency in running the APP.

The method may further include at least one option as follows.

In S21, a model library file may be generated according to the code.

In S22, the APP adapted to executing the target neural network model may be generated by linking the model library file to an executable file.

A library file may be an extended file of an APP generated through a code. An extended file of an APP may not be a complete executable file. A library file may be generated according to the code describing the target neural network. The library file may be linked to an executable file to generate the APP containing a link to the library file. The library file may be called and used at runtime.

A library file may be a static link library. A library file may be a dynamic link library. Both a static link library and a dynamic link library may be extended files independent of an executable file of an APP. A link library may be used in one APP. A link library may be used by different APPs. After a static link library is linked to an executable file, the code of the APP may contain an instruction in the library file straightforwardly, facilitating execution and fast run. On the other hand, only an interface for calling a dynamic link library is linked to an executable file. At runtime, the interface may have to be called to execute an instruction in the library file, although storage space may be saved. Therefore, the specific library file to be used may be decided as needed and is not limited herein.

An encrypted target neural network may be converted into a code. A library file may be generated. An APP linked to the library file may be generated. Therefore, security performance of the target neural network model is improved effectively. In use, data of the target neural network that correspond to a function may be acquired merely by running the APP and calling the function in the library file, facilitating use. The model may be used straightforwardly without being decoded.

In S101, the encrypted model file may be acquired by encrypting the at least a part of the model information in the original model file of the target neural network as follows.

In S31, the encrypted model file may be acquired by performing a mapping operation on the model information according to a preset hash function.

Model information of a target neural network may be encrypted using a hash algorithm. Model information in the target neural network that may be encrypted, including a part or all of the model information, may be acquired. Such parameters may be mapped according to a preset hash function. That is, a hash operation may be performed on the model information to be encrypted, to acquire encrypted model information. Then, an encrypted model file may be acquired. With a hash algorithm, no key may have to be added to model information of a neural network. The model information per se may be mapped. Therefore, with this solution, no key is required for decryption. In addition, with a hash algorithm, a data length will not be increased excessively, reducing waste of storage space due to encryption effectively.

The hash algorithm may be a message digest algorithm MD5. Encryption may be implemented by generating an information/message digest of model information. With an MD5 algorithm, reliability of encryption may be improved, such that each entry of model information may correspond to a unique message digest, i.e., encrypted model information, thereby avoiding a data conflict. In a practical application, another hash algorithm such as a secure hash algorithm sha-2 may be used as need and is not limited herein.

Having received the installation package for installing the APP, the UE may acquire information on the neural network through at least one option as follows.

In option 1, the UE may receive the installation package for installing the APP sent by a server. The installation package may contain the model program code associated with the target neural network model.

The model program code may serve to describe the encrypted model file of the target neural network model. The encrypted model file may be acquired by the server by encrypting at least a part of the model information in the original model file of the target neural network model.

In option 2, the APP may be run. Information on output of the target neural network model may be acquired based on information on input.

The UE may request the target neural network model from the server. Then, the UE may acquire the installation package for installing the APP. The installation package may contain information relevant to the target neural network model. The neural network model may be described by the model program code. Therefore, after the installation package has been installed on the UE, to use the target neural network model, the UE may run the APP. By executing the model program code, the UE may implement the function of the target neural network model.

After the APP, namely the target neural network model, has been provided with specified information on input, the target neural network model may execute the code and acquire output information according to the input information. Therefore, in using the target neural network model, the UE may acquire a result by running the APP straightforwardly without decrypting the encrypted model file thereof. Compared to a model file of a neural network that has to be decrypted with a key, etc., before being used, the solution herein may improve efficiency of use greatly. In addition, when a neural network is deployed off line at a UE side, an original model file may not have to be stored, saving storage space, better meeting a demand for off-line deployment at the UE side. In addition, model information of a neural network may be acquired merely by running a model program code without a need to call an original model file external to the APP, improving efficiency in acquiring information on the neural network, thereby improving overall efficiency in running the APP. Moreover, a server may not have to send a key to a UE side, improving security of transmission, ensuring security of information internal to a model.

In some embodiments, a name of a node in a model may be encrypted using an MD5 algorithm. Then, the encrypted model file may be converted into a C++ code, which may be compiled into a program.

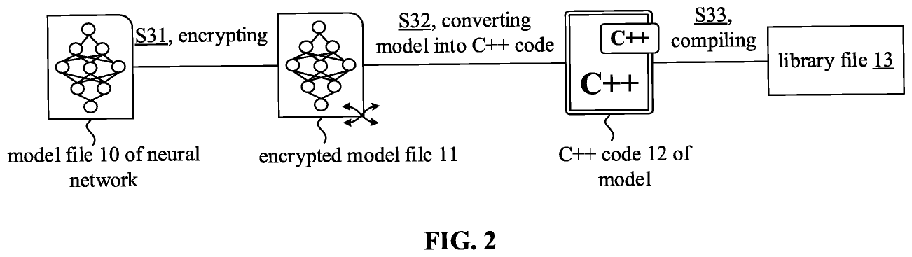

Exemplarily, as shown in FIG. 2, the method may include at least one option as follows.

In S31, an encrypted model file 11 may be acquired by encrypting all node information in a model file 10 of a neural network through MD5.

A neural network model may be a graph structure consisting of nodes. Each node may have information such as a name, a category, input, output, etc. By encrypting such node information through MD5, model information may be concealed, preventing a model structure from being deduced by someone else from information such as a log. In some embodiments, the MD5 encryption algorithm may be replaced with a similar algorithm such as sha-2, sha-256, etc. An sha-256 may provide higher security, but may increase a size of a model file. A person having ordinary skill in the art may select an encryption algorithm as needed by a UE as well as an application scene. In addition, note that FIG. 2 is merely an example of a code adopted herein. The subject disclosure is not limited thereto. Another object-oriented program language, including, but not limited to, JAVA, C#, etc., may also be adopted, for example.

In S32, a C++ code 12 of the model may be acquired by converting the encrypted model file 11 into a C++ code.

The encrypted model file may be a graph structure in a specific format. In converting the encrypted model file into the model program code, the graph structure of the model file may be formed by a number of C++ classes.

For example, each model file may be an object of a Net class. A Net class may include four classes, namely, Tensor, Operator, Argument, and Input/Output Information. A class Tensor may define information on a weight in a model. A class Operator may define node information in a model. A class Argument may define parameter information in a model. A class Input/Output Information may define information on input to the model as well as output of the model.

Information in a model file may be converted into a constructing object in C++ by a function such as CreateNet, CreateTensor, CreateOperator, CreateNetArg, CreateInputInfo, and CreateOutputInfo. Thus, a model file may be converted into a C++ code.

In S33, the C++ code 12 of the model may be compiled and converted to generate a library file 13, which may be a static model library (libmodel.a).

The C++ code of the model may be compiled into a static library. The static library may be linked to an APP. All data of the model may be acquired by calling a function CreateNet when running the APP.

In this way, security and efficiency may be improved effectively. A node of a model file of a neural network may be encrypted. The encrypted node may be converted into a C++ code. The code may be linked to an APP. Therefore, difficulty in cracking a model may be increased greatly, thereby protecting model data and information effectively. A model encrypted in this way may not have to be decrypted at runtime, thereby improving efficiency effectively.

With the solution, a requirement of deploying a neural network model at a UE side for security, efficiency, and storage may be well met.

In encryption of a neural network model at a UE side, three factors may have to be considered, i.e., security, efficiency in decryption, and storage space. Offline encryption of a neural network model at a UE side according to at least one embodiment herein is advantageous in terms of the three factors, as illustrated below.

1) Security is ensured as follows. A name of a node in a model may be encrypted by MD5. Then, an encrypted model file may be converted into a C++ code. The code may be compiled into a program. Information internal to the model is secured by MD5 encryption at an offline stage. Difficulty in cracking the model is increased greatly by converting the model into the code, thereby ensuring security of the entire model.

2) Efficiency in decryption is ensured as follows. Model information may be acquired merely by calling a model function without decryption at runtime, leading to high efficiency.

3) Storage space is saved as follows. A model may be converted into a C++ code, which in practice barely occupies any more storage space, better meeting a demand for deployment of a neural network model at a UE side.

As shown in FIG. 2, encryption may be performed using an MD5 algorithm and a C++ code may be used to describe a neural network model, the subject disclosure is not limited thereto. Another encryption algorithm that a person having ordinary skill in the art may think of may be adopted to encrypt model information of a neural network. Another object-oriented program language may be adopted to describe the neural network.

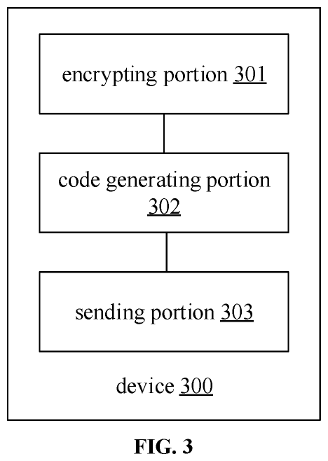

FIG. 3 is a block diagram of a structure of a device for encrypting a neural network model according to some embodiments of the present disclosure. Referring to FIG. 3, the device 300 includes an encrypting portion 301, a code generating portion 302, and a sending portion 303.

The encrypting portion 301 is adapted to acquiring an encrypted model file by encrypting at least a part of model information in an original model file describing a target neural network model.

The code generating portion 302 is adapted to generating, according to the encrypted model file, a model program code describing the target neural network model.

The sending portion 303 is adapted to sending, to a User Equipment (UE) based on a request sent by the UE, an installation package for installing an application (APP). The installation package includes the model program code.

The model information may include node information on each node in the target neural network model and a global parameter of the target neural network model.

The node information may include a node identifier of the each node and a node parameter of the each node.

The node parameter may include at least one of a weight parameter of the each node, an input parameter of the each node, an output parameter of the each node, or an operational parameter of the each node.

The code generating portion may include a constructing sub-portion, a model object creating sub-portion, a data object creating sub-portion, and a generating sub-portion.

The constructing sub-portion may be adapted to constructing a generalized model class associated with the target neural network model, and at least one generalized data class associated with the model information contained in the target neural network model.

The model object creating sub-portion may be adapted to creating, according to the encrypted model file, a model object associated with the target neural network model by calling a model constructing function associated with the generalized model class.

The data object creating sub-portion may be adapted to creating, according to the encrypted model file, a data object associated with the model information by calling at least one data constructing function associated with the at least one generalized data class.

The generating sub-portion may be adapted to generating, according to the model object and the data object, the model program code describing the target neural network model.

The device may further include a library generating portion and an APP generating portion.

The library generating portion may be adapted to generating a model library file according to the model program code.

The APP generating portion may be adapted to generating the APP adapted to executing the target neural network model by linking the model library file to an executable file.

The encrypting portion may include a mapping sub-portion.

The mapping sub-portion may be adapted to acquiring the encrypted model file by performing a mapping operation on the at least a part of the model information according to a preset hash function.

Each portion of the device according to at least one embodiment herein may execute an operation in a mode elaborated in at least one embodiment of the method herein, which will not be repeated here.

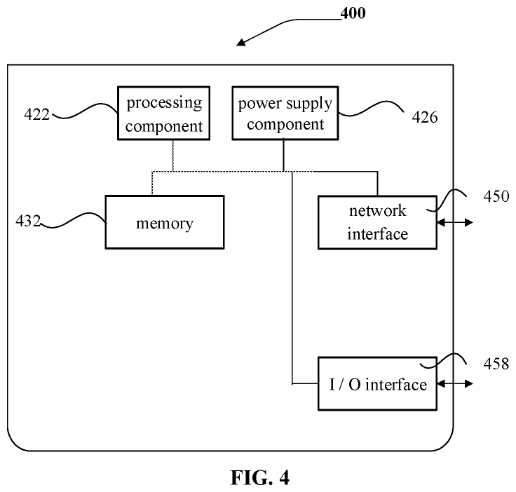

FIG. 4 is a block diagram of a device 400 for acquiring information on output of a neural network model according to some embodiments of the present disclosure. For example, the device 400 may be provided as a server. Referring to FIG. 4, the device 400 may include a processing component 422 (which per se may include one or more processors), and a memory resource indicated by memory 432, adapted to storing instructions, such as an APP, executable by the processing component 422. An APP stored in the memory 432 may include one or more portions each corresponding to a set of instructions. In addition, the processing component 422 may be adapted to executing instructions to execute at least a part of an aforementioned method.

The device 400 may further include a power supply component 426 adapted to managing the power supply of the device 400, a wired or wireless network interface 450 adapted to connecting the device 400 to a network, and an I/O interface 458. The device 400 may operate based on an operating system stored in the memory 432, such as Windows Server™, Mac OS X™, Unix™, Linux™, FreeBSD™, or the like.

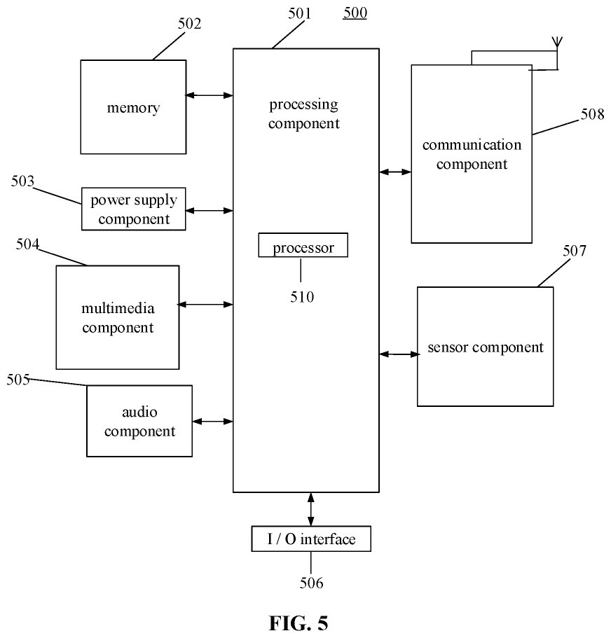

FIG. 5 is a block diagram of a UE 500 according to some embodiments of the present disclosure. The UE 500 is adapted to executing at least a part of any method for encrypting a neural network model according to at least one embodiment herein. For example, the UE 500 may be a mobile phone, a computer, a digital broadcast UE, a messaging device, a gaming console, a tablet, a medical device, exercise equipment, a personal digital assistant, etc.

Referring to FIG. 5, the UE 500 may include at least one of a processing component 501, memory 502, a power supply component 503, a multimedia component 504, an audio component 505, an Input/Output (I/O) interface 506, a sensor component 507, or a communication component 508.

The processing component 501 may generally control an overall operation of the UE 500, such as operations associated with display, a telephone call, data communication, a camera operation, a recording operation, etc. The processing component 501 may include one or more processors 510 to execute instructions so as to complete all or a part of an aforementioned method. In addition, the processing component 501 may include one or more modules to facilitate interaction between the processing component 501 and other components. For example, the processing component 501 may include a multimedia module to facilitate interaction between the multimedia component 504 and the processing component 501.

The memory 502 may be adapted to storing various types of data to support the operation at the UE 500. Examples of such data may include instructions of any application or method adapted to operating on the UE 500, contact data, phonebook data, messages, pictures, videos, etc. The memory 502 may be realized by any type of transitory or non-transitory storage equipment or a combination thereof, such as Static Random-Access Memory (SRAM), Electrically Erasable Programmable Read-Only Memory (EEPROM), Erasable Programmable Read-Only Memory (EPROM), Programmable Read-Only Memory (PROM), Read-Only Memory (ROM), magnetic memory, flash memory, a magnetic disk, a compact disk, etc.

The power supply component 503 may supply electric power to various components of the UE 500. The power supply component 503 may include a power management system, one or more power sources, and other components related to generating, managing, and distributing electricity for the UE 500.

The multimedia component 504 may include a screen that provides an output interface between the UE 500 and a user. The screen may include a Liquid Crystal Display (LCD), a Touch Panel (TP). In some embodiments, organic light-emitting diode (OLED) or other types of displays can be employed. If the screen includes a TP, the screen may be realized as a touch screen to receive a signal input by a user. The TP may include one or more touch sensors for sensing touch, slide, and gestures on the TP. The one or more touch sensors not only may sense the boundary of a touch or slide move, but also detect the duration and pressure related to the touch or slide move. The multimedia component 504 may include at least one of a front camera or a rear camera. When the UE 500 is in an operation mode such as a photographing mode or a video mode, at least one of the front camera or the rear camera may receive external multimedia data. Each of the front camera or the rear camera may be a fixed optical lens system or may have a focal length and be capable of optical zooming.

The audio component 505 may be adapted to outputting and/or inputting an audio signal. For example, the audio component 505 may include a microphone (MIC). When the UE 500 is in an operation mode such as a call mode, a recording mode, a voice recognition mode, etc., the MIC may be adapted to receiving an external audio signal. The received audio signal may be further stored in the memory 502 or may be sent via the communication component 508. The audio component 505 may further include a loudspeaker adapted to outputting the audio signal.

The I/O interface 506 may provide an interface between the processing component 501 and a peripheral interface module. Such a peripheral interface module may be a keypad, a click wheel, a button, etc. Such a button may include but is not limited to at least one of a homepage button, a volume button, a start button, or a lock button.

The sensor component 507 may include one or more sensors for assessing various states of the UE 500. For example, the sensor component 507 may detect an on/off state of the UE 500 and relative positioning of components such as the display and the keypad of the UE 500. The sensor component 507 may further detect a change in the position of the UE 500 or of a component of the UE 500, whether there is contact between the UE 500 and a user, the orientation or acceleration/deceleration of the UE 500, a change in the temperature of the UE 500, etc. The sensor component 507 may include a proximity sensor adapted to detecting existence of a nearby object without physical contact. The sensor component 507 may further include an optical sensor such as a Complementary Metal-Oxide-Semiconductor (CMOS) or a Charge-Coupled-Device (CCD) image sensor used in an imaging application. The sensor component 507 may further include an acceleration sensor, a gyroscope sensor, a magnetic sensor, a pressure sensor, a temperature sensor, etc.

The communication component 508 may be adapted to facilitating wired or wireless communication between the UE 500 and other equipment. The UE 500 may access a wireless network based on a communication standard such as Wi-Fi, 2G, 3G . . . , or a combination thereof. The communication component 508 may broadcast related information or receive a broadcast signal from an external broadcast management system via a broadcast channel. The communication component 508 may include a Near Field Communication (NFC) module for short-range communication. For example, the NFC module may be based on technology such as Radio Frequency Identification (RFID), Infrared Data Association (IrDA), Ultra-Wideband (UWB) technology, Bluetooth (BT), etc.

The UE 500 may be realized by one or more electronic components such as an Application Specific Integrated Circuit (ASIC), a Digital Signal Processor (DSP), a Digital Signal Processing Device (DSPD), a Programmable Logic Device (PLD), a Field Programmable Gate Array (FPGA), a controller, a microcontroller, a microprocessor, etc., to implement an aforementioned method.

A device for encrypting a neural network model according to at least one embodiment hererin includes at least a processor and memory.

The memory stores an instruction executable by the processor.

When executed by the processor, the instruction implements at least a part of a method for encrypting a neural network model. The method includes:

acquiring an encrypted model file by encrypting at least a part of model information in an original model file describing a target neural network model;

generating, according to the encrypted model file, a model program code describing the target neural network model; and

sending, to a User Equipment (UE) based on a request sent by the UE, an installation package for installing an application (APP), the installation package comprising the model program code.

A non-transitory computer-readable storage medium according to at least one embodiment herein has stored thereon computer-executable instructions that, when executed by a processor, cause the processor to implement at least a part of a method for encrypting a neural network model. The method includes:

acquiring an encrypted model file by encrypting at least a part of model information in an original model file describing a target neural network model;

generating, according to the encrypted model file, a model program code describing the target neural network model; and

sending, to a User Equipment (UE) based on a request sent by the UE, an installation package for installing an application (APP), the installation package comprising the model program code.

A non-transitory computer-readable storage medium including instructions, such as memory 502 including instructions, may be provided. The instructions may be executed by the processor 510 of the UE 500 to implement an aforementioned method. For example, the non-transitory computer-readable storage medium may be Read-Only Memory (ROM), Random-Access Memory (RAM), Compact Disc Read-Only Memory (CD-ROM), a magnetic tape, a floppy disk, optical data storage equipment, etc.

A non-transitory computer-readable storage medium may include instructions which when executed by a processor of a mobile UE, may cause the mobile UE to implement a method for encrypting a neural network model. The method includes at least one option as follows.

An encrypted model parameter is acquired by encrypting at least one model parameter of a target neural network.

A code describing the target neural network is generated according to the encrypted model parameter.

A non-transitory computer-readable storage medium may include instructions which when executed by a processor of a mobile UE, may cause the mobile UE to implement a method for decrypting a neural network model. The method includes at least one option as follows.

An APP adapted to executing a target neural network model is run. The APP contains a code describing at least one encrypted model parameter of the target neural network.

Data of the target neural network is acquired according to the APP that is run.

The processor may be a Central Processing Unit (CPU), a general-purpose processor, a Digital Signal Processor (DSP), an Application Specific Integrated Circuit (ASIC), and/or the like. A general-purpose processor may be a microprocessor, any conventional processor, and/or the like. Aforementioned memory may be a Read-Only Memory (ROM), a flash memory, a hard disk, a solid-state disk, and/or the like. A Subscriber Identity Module (SIM) card, also referred to as a smart card, may have to be installed on a digital mobile phone before the phone can be used. Content, such as information on a user of the digital mobile phone, an encryption key, a phonebook of the user, may be stored on the computer chip. An option of the method according to any combination of embodiments herein may be executed by a hardware processor, or by a combination of hardware and software modules in the processor.

The various device components, circuits, modules, units, blocks, or portions may have modular configurations, or are composed of discrete components, but nonetheless may be referred to as “modules” in general. In other words, the “components,” “circuits,” “modules,” “units,” “blocks,” or “portions” referred to herein may or may not be in modular forms.

In the present disclosure, the terms “installed,” “connected,” “coupled,” “fixed” and the like shall be understood broadly, and can be either a fixed connection or a detachable connection, or integrated, unless otherwise explicitly defined. These terms can refer to mechanical or electrical connections, or both. Such connections can be direct connections or indirect connections through an intermediate medium. These terms can also refer to the internal connections or the interactions between elements. The specific meanings of the above terms in the present disclosure can be understood by those of ordinary skill in the art on a case-by-case basis.

In the description of the present disclosure, the terms “one embodiment,” “some embodiments,” “example,” “specific example,” or “some examples,” and the like can indicate a specific feature described in connection with the embodiment or example, a structure, a material or feature included in at least one embodiment or example. In the present disclosure, the schematic representation of the above terms is not necessarily directed to the same embodiment or example.

Moreover, the particular features, structures, materials, or characteristics described can be combined in a suitable manner in any one or more embodiments or examples. In addition, various embodiments or examples described in the specification, as well as features of various embodiments or examples, can be combined and reorganized.

In some embodiments, the control and/or interface software or app can be provided in a form of a non-transitory computer-readable storage medium having instructions stored thereon is further provided. For example, the non-transitory computer-readable storage medium can be a ROM, a CD-ROM, a magnetic tape, a floppy disk, optical data storage equipment, a flash drive such as a USB drive or an SD card, and the like.

Implementations of the subject matter and the operations described in this disclosure can be implemented in digital electronic circuitry, or in computer software, firmware, or hardware, including the structures disclosed herein and their structural equivalents, or in combinations of one or more of them. Implementations of the subject matter described in this disclosure can be implemented as one or more computer programs, i.e., one or more portions of computer program instructions, encoded on one or more computer storage medium for execution by, or to control the operation of, data processing apparatus.

Alternatively, or in addition, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them.

Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, drives, or other storage devices). Accordingly, the computer storage medium can be tangible.

The operations described in this disclosure can be implemented as operations performed by a data processing apparatus on data stored on one or more computer-readable storage devices or received from other sources.

The devices in this disclosure can include special purpose logic circuitry, e.g., an FPGA (field-programmable gate array), or an ASIC (application-specific integrated circuit). The device can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The devices and execution environment can realize various different computing model infrastructures, such as web services, distributed computing, and grid computing infrastructures.

A computer program (also known as a program, software, software application, app, script, or code) can be written in any form of programming language, including compiled or interpreted languages, declarative or procedural languages, and it can be deployed in any form, including as a stand-alone program or as a portion, component, subroutine, object, or other portion suitable for use in a computing environment. A computer program can, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more portions, sub-programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform actions by operating on input data and generating output. The processes and logic flows can also be performed by, and apparatus can also be implemented as, special purpose logic circuitry, e.g., an FPGA, or an ASIC.

Processors or processing circuits suitable for the execution of a computer program include, by way of example, both general and special purpose microprocessors, and any one or more processors of any kind of digital computer. Generally, a processor will receive instructions and data from a read-only memory, or a random-access memory, or both. Elements of a computer can include a processor configured to perform actions in accordance with instructions and one or more memory devices for storing instructions and data.

Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented with a computer and/or a display device, e.g., a VR/AR device, a head-mount display (HMD) device, a head-up display (HUD) device, smart eyewear (e.g., glasses), a CRT (cathode-ray tube), LCD (liquid-crystal display), OLED (organic light emitting diode), or any other monitor for displaying information to the user and a keyboard, a pointing device, e.g., a mouse, trackball, etc., or a touch screen, touch pad, etc., by which the user can provide input to the computer.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components.

The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many specific implementation details, these should not be construed as limitations on the scope of any claims, but rather as descriptions of features specific to particular implementations. Certain features that are described in this specification in the context of separate implementations can also be implemented in combination in a single implementation. Conversely, various features that are described in the context of a single implementation can also be implemented in multiple implementations separately or in any suitable subcombination.

Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

As such, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing can be utilized.

It is intended that the specification and embodiments be considered as examples only. Other embodiments of the disclosure will be apparent to those skilled in the art in view of the specification and drawings of the present disclosure. That is, although specific embodiments have been described above in detail, the description is merely for purposes of illustration. It should be appreciated, therefore, that many aspects described above are not intended as required or essential elements unless explicitly stated otherwise.

It should be understood that “a plurality” or “multiple” as referred to herein means two or more. “And/or,” describing the association relationship of the associated objects, indicates that there may be three relationships, for example, A and/or B may indicate that there are three cases where A exists separately, A and B exist at the same time, and B exists separately. The character “/” generally indicates that the contextual objects are in an “or” relationship.

Some other embodiments of the present disclosure can be available to those skilled in the art upon consideration of the specification and practice of the various embodiments disclosed herein. The present application is intended to cover any variations, uses, or adaptations of the present disclosure following general principles of the present disclosure and include the common general knowledge or conventional technical means in the art without departing from the present disclosure. The specification and examples can be shown as illustrative only, and the true scope and spirit of the disclosure are indicated by the following claims.

1. A method for encrypting a neural network model, comprising:
acquiring an encrypted model file by encrypting at least a part of model information in an original model file describing a target neural network model;
generating, according to the encrypted model file, a model program code describing the target neural network model; and
sending, to a User Equipment (UE) based on a request sent by the UE, an installation package for installing an application (APP), the installation package comprising the model program code.

2. The method of claim 1, wherein the model information comprises node information on each node in the target neural network model and a global parameter of the target neural network model,
wherein the node information comprises a node identifier of the each node and a node parameter of the each node,
wherein the node parameter comprises at least one of a weight parameter of the each node, an input parameter of the each node, an output parameter of the each node, or an operational parameter of the each node.

3. The method of claim 1, wherein the generating, according to the encrypted model file, a model program code describing the target neural network model comprises:
constructing a generalized model class associated with the target neural network model, and at least one generalized data class associated with the model information contained in the target neural network model;
creating, according to the encrypted model file, a model object associated with the target neural network model by calling a model constructing function associated with the generalized model class;
creating, according to the encrypted model file, a data object associated with the model information by calling at least one data constructing function associated with the at least one generalized data class; and
generating, according to the model object and the data object, the model program code describing the target neural network model.

4. The method of claim 1, further comprising:
generating a model library file according to the model program code; and
generating the APP adapted to executing the target neural network model by linking the model library file to an executable file.

5. The method of claim 1, wherein the acquiring an encrypted model file by encrypting at least a part of model information in an original model file describing a target neural network model comprises:
acquiring the encrypted model file by performing a mapping operation on the at least a part of the model information according to a preset hash function.

6. The method of claim 2, wherein the acquiring an encrypted model file by encrypting at least a part of model information in an original model file describing a target neural network model comprises:
acquiring the encrypted model file by performing a mapping operation on the at least a part of the model information according to a preset hash function.

7. The method of claim 3, wherein the acquiring an encrypted model file by encrypting at least a part of model information in an original model file describing a target neural network model comprises:
acquiring the encrypted model file by performing a mapping operation on the at least a part of the model information according to a preset hash function.

8. The method of claim 4, wherein the acquiring an encrypted model file by encrypting at least a part of model information in an original model file describing a target neural network model comprises:
acquiring the encrypted model file by performing a mapping operation on the at least a part of the model information according to a preset hash function.

9. A device for encrypting a neural network model, comprising at least a processor and memory,
wherein the memory stores an instruction executable by the processor,
wherein when executed by the processor, the instruction implements at least a part of a method for encrypting a neural network model, the method comprising:
acquiring an encrypted model file by encrypting at least a part of model information in an original model file describing a target neural network model;
generating, according to the encrypted model file, a model program code describing the target neural network model; and
sending, to a User Equipment (UE) based on a request sent by the UE, an installation package for installing an application (APP), the installation package comprising the model program code.

10. The device of claim 9, wherein the model information comprises node information on each node in the target neural network model and a global parameter of the target neural network model,
wherein the node information comprises a node identifier of the each node and a node parameter of the each node,
wherein the node parameter comprises at least one of a weight parameter of the each node, an input parameter of the each node, an output parameter of the each node, or an operational parameter of the each node.

11. The device of claim 9, wherein the generating, according to the encrypted model file, a model program code describing the target neural network model comprises:
constructing a generalized model class associated with the target neural network model, and at least one generalized data class associated with the model information contained in the target neural network model;
creating, according to the encrypted model file, a model object associated with the target neural network model by calling a model constructing function associated with the generalized model class;
creating, according to the encrypted model file, a data object associated with the model information by calling at least one data constructing function associated with the at least one generalized data class; and
generating, according to the model object and the data object, the model program code describing the target neural network model.

12. The device of claim 9, wherein the method further comprises:
generating a model library file according to the model program code; and
generating the APP adapted to executing the target neural network model by linking the model library file to an executable file.

13. The device of claim 9, wherein the acquiring an encrypted model file by encrypting at least a part of model information in an original model file describing a target neural network model comprises:
acquiring the encrypted model file by performing a mapping operation on the at least a part of the model information according to a preset hash function.

14. The device of claim 10, wherein the acquiring an encrypted model file by encrypting at least a part of model information in an original model file describing a target neural network model comprises:
acquiring the encrypted model file by performing a mapping operation on the at least a part of the model information according to a preset hash function.

15. The device of claim 11, wherein the acquiring an encrypted model file by encrypting at least a part of model information in an original model file describing a target neural network model comprises:
acquiring the encrypted model file by performing a mapping operation on the at least a part of the model information according to a preset hash function.

16. The device of claim 12, wherein the acquiring an encrypted model file by encrypting at least a part of model information in an original model file describing a target neural network model comprises:
acquiring the encrypted model file by performing a mapping operation on the at least a part of the model information according to a preset hash function.

17. A non-transitory computer-readable storage medium having stored thereon computer-executable instructions that, when executed by a processor, cause the processor to implement at least a part of a method for encrypting a neural network model, the method comprising:
acquiring an encrypted model file by encrypting at least a part of model information in an original model file describing a target neural network model;
generating, according to the encrypted model file, a model program code describing the target neural network model; and
sending, to a User Equipment (UE) based on a request sent by the UE, an installation package for installing an application (APP), the installation package comprising the model program code.

18. The storage medium of claim 17, wherein the model information comprises node information on each node in the target neural network model and a global parameter of the target neural network model,
wherein the node information comprises a node identifier of the each node and a node parameter of the each node,
wherein the node parameter comprises at least one of a weight parameter of the each node, an input parameter of the each node, an output parameter of the each node, or an operational parameter of the each node.

19. The storage medium of claim 17, wherein the generating, according to the encrypted model file, a model program code describing the target neural network model comprises:
constructing a generalized model class associated with the target neural network model, and at least one generalized data class associated with the model information contained in the target neural network model;
creating, according to the encrypted model file, a model object associated with the target neural network model by calling a model constructing function associated with the generalized model class;
creating, according to the encrypted model file, a data object associated with the model information by calling at least one data constructing function associated with the at least one generalized data class; and
generating, according to the model object and the data object, the model program code describing the target neural network model.

20. The storage medium of claim 17, wherein the method further comprises:
generating a model library file according to the model program code; and
generating the APP adapted to executing the target neural network model by linking the model library file to an executable file.
